(19) United States
(12) Patent Application Publication
(10) Pub. No.: US 2025/0293524 A1
(43) Pub. Date: Sep. 18, 2025

(54) MODULAR POWER HUB

(71) Applicant: SUNRISE GLOBAL MARKETING, LLC, Mooresville, NC (US)

(72) Inventors: Klaus Hahn, Brasselton, GA (US); Daniel Hopman, Mooresville, NC (US); Chris Peterson, Mooresville, NC (US); Jason Swanson, Mooresville, NC (US)

(21) Appl. No.: 18/872,963

(22) PCT Filed: Jun. 13, 2023
(86) PCT No.: PCT/US2023/068325

§ 371 Date: Dec. 9, 2024

Related U.S. Application Data
(60) Provisional application No. 63/351,567, filed on Jun. 13, 2022.

(51) Int. Cl. H02J 3/32; B60L 55/00; G08B 21/18; H02J 7/00

(52) U.S. Cl. CPC H02J 3/322; B60L 55/00; G08B 21/182; H02J 7/00034; H02J 7/005; H02J 7/0071; H02J 2207/20

(57) ABSTRACT

A modular power hub includes: an inverter/charger module; a battery control module; and a storage battery, wherein the inverter/charger module is operable to: receive electric grid power and to charge at least one of: a removable battery coupled to the battery control module and the storage battery; and receive electric current from at least one of: a removable battery coupled to the battery control module and the storage battery, and convert that electric current to AC current.

### BACKGROUND OF THE INVENTION

This invention relates generally to electric power management and more particularly to home battery charging equipment.

Battery-powered vehicles and equipment are in widespread use. For home use, the batteries are typically charged using individual chargers or power supply equipment for each type and brand of vehicle or equipment.

It is also becoming more common to equip homes with renewable energy sources such as photovoltaic cells. These require power management equipment to distribute electric power throughout the home and to safely the connect electric power grid. It is also desirable to provide storage for load management.

One problem with these trends is that implementation of the various electric devices requires multiple types of power management equipment and the various pieces of equipment often duplicate some or all functions.

### BRIEF SUMMARY OF THE INVENTION

This problem is addressed by a modular power hub which integrates multiple electric power management functions into a single device.

According to one aspect of the technology described herein, a modular power hub includes: an inverter/charger module; a battery control module; and a storage battery, wherein the inverter/charger module is operable to: receive electric grid power and to charge at least one of: a removable battery coupled to the battery control module and the storage battery; and receive electric current from at least one of: a removable battery coupled to the battery control module and the storage battery, and convert that electric current to AC current.

### BRIEF DESCRIPTION OF THE DRAWINGS

The invention may be best understood by reference to the following description taken in conjunction with the accompanying drawing figures in which:

FIG. 1 is a schematic view of a home equipped with a modular power hub;

FIG. 2 is a diagram of a battery energy storage system using a power hub with solar, smart home, EV, mower, and power station charging options;

FIG. 3 is a front view showing primary and secondary cabinets comprising the power hub;

FIG. 4 is a view of the primary cabinet of FIG. 3, with doors open showing the internal components;

FIG. 5 is a view of the secondary cabinet of FIG. 3, with doors open showing the internal components; and

FIG. 6 is a view of a hub with outdoor power equipment and associated removable batteries.

### DETAILED DESCRIPTION OF THE INVENTION

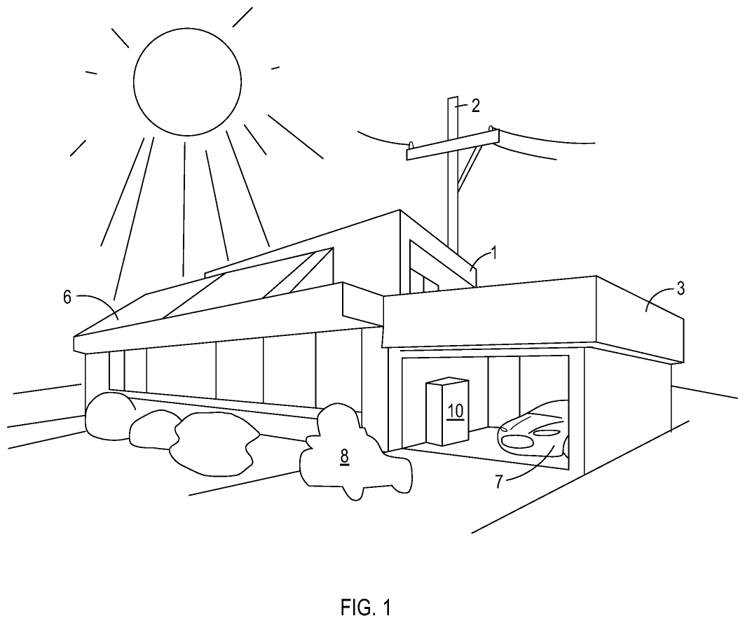

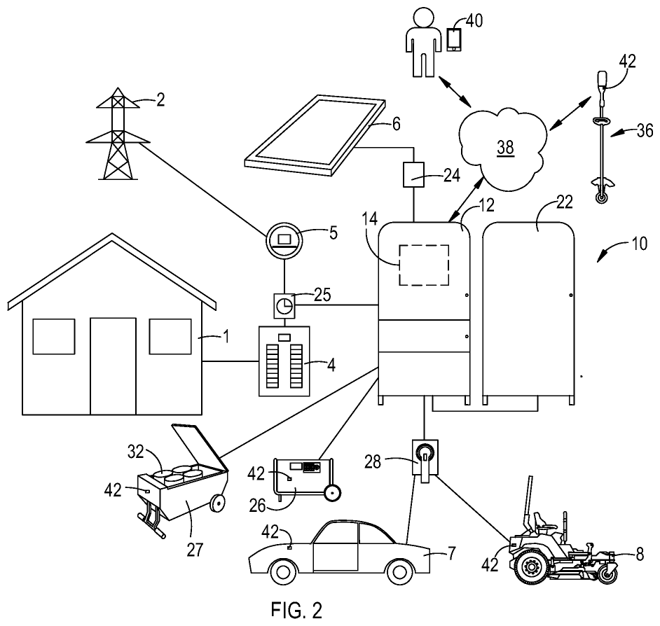

The present invention relates to a modular power hub or battery energy storage system. This has multiple electrical power functions. In essence, the modular power hub acts as a central device providing storage and two-way conversion of electrical power (AC to DC, DC to AC) as well as voltage step-up and step-down. Referring to the drawings, FIGS. 1 and 2 illustrate various aspects and components of exemplary embodiments of the modular power hub.

FIG. 1 in particular illustrates a house 1 having a connection to a utility power grid 2, which typically supplies electric power at 120 V to 240 V AC. The voltage, phase, and/or AC frequency will vary depending on specific circumstances. A standalone single-family residence with an attached garage 3 is shown as an example. It will be understood that the modular power hub described herein is suitable for any type of commercial or residential building. It will be further understood that the house 1 includes an electrical system which receives utility grid power and distributes it to one or more circuits to power devices of the house such as HVAC equipment, lighting, and receptacles for portable equipment. As seen in FIG. 2, the electrical system includes a load center 4 such as the illustrated circuit breaker panel, which is coupled to the power grid 2 through an electric meter 5. Optionally, the house 1 is equipped with a supplemental power source such as the illustrated photovoltaic panels 6 (alternatively referred to “PV” or “solar panels”).

A modular power hub 10 is disposed in a suitable location within or near the building, such as the garage 3.

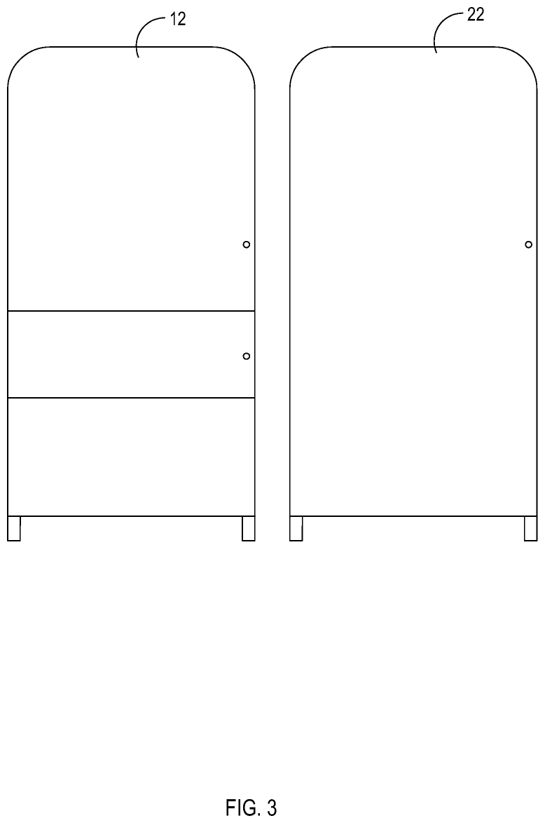

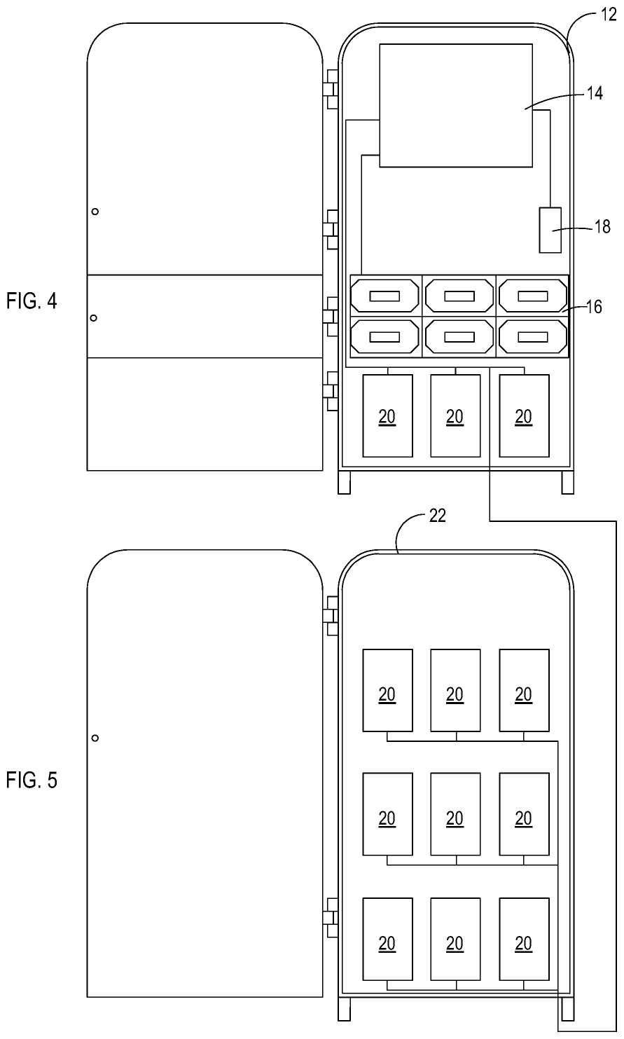

An example of the physical configuration of the power hub 10 is shown in FIGS. 3-5. The power hub 10 includes a primary cabinet 12 which encloses the main components, namely: an inverter/charger module 14, a battery control module 16, a transceiver 18, and one or more rechargeable storage batteries 20. Appropriate power and data connections are provided between the components, these being shown by single lines in the drawings.

Optionally, the power hub 10 may include one or more secondary cabinets 22 that house one or more rechargeable storage batteries 20. The purpose of the secondary cabinets 22 is to increase the total energy storage capacity of the system.

Referring back to FIG. 2, the hub 10 serves as a central switching, routing, and storage element within a battery energy storage system. The system is modular and can be configured to accommodate various power sources, functions, and devices. In FIG. 2, the hub 10 is coupled to the photovoltaic panels 6. The connection may be either directly to the inverter/charger module 14, or through an optional separate inverter 24.

The hub 10 is coupled to the load center 4 which in turn is coupled to the electrical system of the house 1, and to the power grid 2 (via meter 5). Means are provided for isolating the power grid 2 from the load center 4. In the illustrated example, a standalone transfer switch 25 is shown. It will be understood that the transfer switch function may be incorporated into the hub 10, for example in the inverter/charger module 14.

In FIG. 2, the hub 10 is coupled to an optional generator 26 which is operable to supply electric current. This generator may comprise an electromechanical generator driven by a prime mover such as an internal combustion engine. Alternatively, it may comprise a bank of batteries coupled to an inverter for providing AC current output.

In FIG. 2, the hub 10 is coupled to an optional portable battery carrier 27. The battery carrier 27 includes physical and electrical connections for one or more removable batteries 32 as described herein. This is configured as a tray or enclosure with a lid or similar arrangement, that they can be carried and/or wheeled to a location of use. Multiple of these battery carriers 27 can be “daisy-chained”, for example as a vertical stack or individually arranged against a wall or mounted to wall. Appropriate charging logic allows for simultaneous charging to equal levels for the batteries 32 in each battery carrier 27 at the same time. The battery carrier 27 may be equipped with displays the and/or LEDs indicating the charge status of the battery carrier 27 and/or individual batteries therein. The battery carrier 27 may be equipped with a tracking device 42 as described herein.

In FIG. 2, the hub 10 is coupled to an electric vehicle supply equipment (“EVSE”) device 28 which is operable to supply charging current to an electric vehicle (“EV”) such as the illustrated automobile 7 or riding mower 8. For example, the EVSE device 28 may follow the J1772 standard. Optionally, the EVSE device 28 may be operable to transfer electric power from an EV such as the illustrated automobile 7 or riding mower 8 to the hub 10.

The inverter/charger module 14 may be operable to receive line voltage, e.g., 120 V to 240 V AC and to supply AC current at one or more predetermined voltages. It may accomplish this function by use of one or more transformers and associated components.

The inverter/charger module 14 may be operable to receive line voltage and to supply DC current at one or more predetermined voltages. It may accomplish this function by the use of one or more rectifiers, DC-DC converters, and associated components.

The inverter/charger module 14 may be operable to receive DC current and to supply AC current at one or more predetermined voltages, e.g., 120 V to 240 V AC. It may accomplish this function by use of one or more inverters, transformers, and associated components.

The primary cabinet 12 houses one or more of the rechargeable storage batteries 20 internally. The storage batteries 20 may be charged with current from the inverter/charger module 14. The source of that current may be the power grid 2 or the supplemental power source 6. As used herein, the term “battery” is considered to encompass any device suitable for storing and discharging electrical energy. In the illustrated example, each storage battery 20 includes one or more chemical cells, for example lithium ion cells. Other liquid battery chemistries may be substituted, as well as solid state batteries, capacitors, or similar devices which may exist currently or be later developed. The storage batteries 20 may be bare cells, or they may include ancillary electrical components such as, transformers, voltage converters, relays, circuit breakers, and/or sensors for determining parameters such as state of charge (e.g., temperature sensors, specific gravity sensors).

The storage batteries 20 have a capacity selected to provide adequate energy reserve for the intended use. More or larger batteries may be used for more energy storage, with attendant increased cost and space requirement. In one example, a storage battery capacity of approximately 8 kWH may be provided. This amount of energy could provide lighting for several days, or operate a refrigerator for approximately half a day.

The inverter/charger module 14 may be operable to power EVSE device 28 by providing AC or DC electric current at an appropriate voltage.

The inverter/charger module 14 may be operable to selectively couple a power source to the load center 4, For example, one of the utility power grid 2, the supplemental power source 6, the storage batteries 20, the removable batteries 32, the generator 26, or an EV may be coupled to the load center 4. Stated another way, the inverter/charger module 14 allows for bi-directional flow of power. For example, the batteries removable or integrated into the riding mower 8 (or any of the other pieces of equipment described herein) may provide additional home backup capacity. The inverter/charger module 14 may accomplish this function by use of one or more relays and associated components. When one of the power sources other than the power grid 2 is to be used, the load center 4 would be isolated from the power grid 2 for safety purposes. When a power source that provides DC current is to be used, the inverter function of the inverter/charger module 14 would convert the DC current to AC current. Use of power from the storage batteries 20 or other non-grid source provides backup power in case of a grid outage. It also permits battery charging during off-peak times. The stored energy can then be used instead of grid power during peak times.

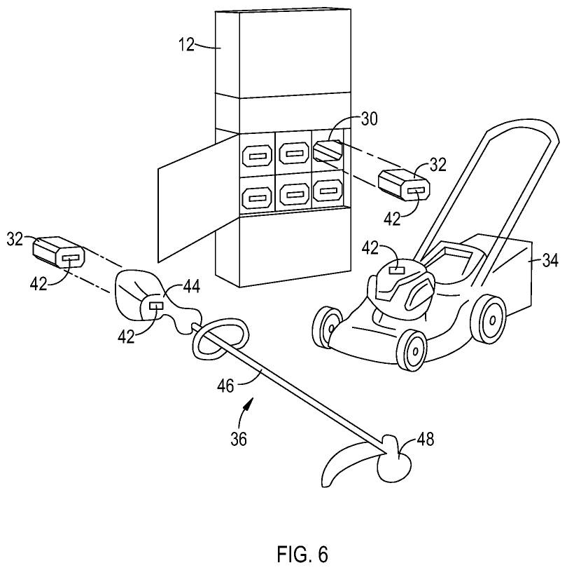

Referring to FIG. 6, the battery control module 16 includes receptacles 30 providing physical and electrical connections for one or more removable batteries 32. Example removable batteries 32 may be rated at voltages such as 24 V, 40 V, 60 V, or 80 V (nonlimiting examples) and have an amp-hour capacity, size, and weight suitable for use with portable equipment such as lawn and garden equipment. The removable batteries 32 may have different physical configurations such as slide mount or post mount. FIG. 6 illustrates a walk-behind lawnmower 34 and a string trimmer 36. These are just two of many examples of devices that may be powered using removable batteries 32.

DC electric power from the removable batteries 32 may be converted to AC electric power by the inverter/charger module 14 and then supplied to the house 1 through the load center 4.

Electric power from the storage batteries 20 may be used for various functions such as charging one or more of the removable batteries 32.

The transceiver 18 enables two-way data communication, and may be combined with an appropriate power supply, display, and controls as required. For example, it may include a short range transceiver such as Wi-Fi or Bluetooth, or a longer-range protocol such as a cellular transceiver (e.g. 4G, 5G network protocol). Network communications may be wired or wireless. Using the transceiver 18, the hub 18 may communicates with other system components through a wide-area network 38, such as the Internet. Network communications may be wired or wireless (e.g. Wi-Fi or cellular networks).

Operation of the modular power hub 10 may be controlled by one or more software applications (“apps”) providing for remote information, diagnostics, and/or control. The app may be implemented on a management device 40 communicating with the hub 10 through the wide-area network 38. It will be understood that the management device 40 may be embodied as a conventional desktop computer or a mobile computing device (e.g. smart phone or tablet computer) programmed with appropriate software. In the illustrated example, the management device 40 is a smartphone hosting a management app.

One or more of the battery-powered devices associated with the hub 10 may be provided with a tracking device 42, which are in data communication with the hub 10 through the wide-area network 38.

Each tracking device 42 incorporates one or more processors operable to execute programmed software code as well as at least one transceiver to enable two way data communication, along with an appropriate power supply, display, and controls as required. The tracking device 42 may be configured to communicate over a short-range data protocol such as Wi-Fi, Bluetooth, or Bluetooth low energy (BLE). Additionally or alternatively, the tracking device 42 may incorporate a longer-range data protocol such as cellular (e.g. 4G, 5G networks). FIG. 6 illustrates an example tool in the form of a string trimmer 36 having a power head 44 with a removable, rechargeable battery pack 32, a shaft 46, and a rotating trimmer head 48. A first tracking device 42 is located internal to the power head 44, as shown schematically in this figure. A second tracking device 42 is located internal to the removable battery pack 32, shown schematically.

Optionally, the tracking device 42 may implement at least one location service, defined as a combination of hardware and software operable to determine the geographic location of the tracking device 42. Nonlimiting examples of location services include inertial navigation systems, satellite-based navigation (e.g. GPS, GLONASS, BeiDou, Galileo, IRNSS, or QESS), Wi-Fi-based location, and cellular-based location.

The app has various potential uses. For example, it may be programmed to display an “asset dashboard” on the management device 40 which permits viewing of the status of the various devices as reported by the tracking devices 42. More specifically, the application may be programmed to collect, analyze, and manipulate data and produce output formatted for display on the management device 40. For example, the asset dashboard may display icons or other information showing the location of each item, the movement of the item superimposed on a map, and/or a log of the item movements over a given period of time.

The app may be used to provide Internet of things (“IoT”) power management for each battery or battery-powered device. For example, the app could be used to display charge/discharge information for each device, and/or to control a charge/discharge cycle for each device. It may also be used to display an end of life or state of charge (“SOC”) prediction for each device. It may also be used to display fault alerts in response to sensor signals, or theft alerts based on user-defined geofencing boundaries.

The modular hub described above has certain benefits and advantages. It can provide cost savings by allowing storage of grid power received at off-peak times or from alternative energy sources. It can provide backup power during grid outages. It can reduce emissions, especially CO2, by reducing the consumption of grid power. especially. It may permit a homeowner to benefit from government tax credits and/or increased home value.

The foregoing has described a modular power hub. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. A modular power hub, comprising:
an inverter/charger module;
a battery control module; and
a storage battery, wherein the inverter/charger module is operable to:
receive electric grid power and to charge at least one of: a removable battery coupled to the battery control module and the storage battery; and
receive electric current from at least one of: a removable battery coupled to the battery control module and the storage battery, and convert that electric current to AC current.

2. The modular power hub of claim 1, wherein the inverter/charger module is connected to a load center of a building.

3. The modular power hub of claim 1, further comprising an electric vehicle supply equipment device coupled to the inverter/charger module.

4. The modular power hub of claim 1, further comprising a transceiver operably coupled to the inverter/charger module.

5. The modular power hub of claim 1, further comprising:
a tracking device for being disposed on a battery-powered item;
a management device;
a software application in data communication with the tracking device and the management device, the software application programmed to receive information from the tracking device, process the received information, and transmit the processed information to the management device.

6. The modular power hub of claim 1, wherein the software application is programmed to control a charging cycle of the battery-powered item when the battery-powered item is coupled to the inverter/charger module.

7. The modular power hub of claim 5, wherein the software application is programmed to track charge/discharge information for the battery-powered device, in response to signals from the tracking device.

8. The modular power hub of claim 5, wherein the software application is programmed display an end of life prediction for the battery-powered device.

9. The modular power hub of claim 5, wherein the software application is programmed to track display fault alerts in response to sensor signals from the tracking device.

10. The modular power hub of claim 5, wherein the software application is programmed to track the location of the tracking device and to display a theft alert moved outside a user-defined geofencing boundary.
